(19) United States
(12) Patent Application Publication
(10) Pub. No.: US 2013/0181919 A1
(43) Pub. Date: Jul. 18, 2013

(54) ELECTRONIC DEVICE AND METHOD FOR CONTROLLING THE SAME

(71) Applicant: Wistron Corp., New Taipei City (TW)

(72) Inventor: Pei-Jung Yu, New Taipei City (TW)

(73) Assignee: WISTRON CORP., New Taipei City (TW)

(21) Appl. No.: 13/720,817

(22) Filed: Dec. 19, 2012

(30) Foreign Application Priority Data
Jan. 17, 2012 (TW) 101101673

(51) Int. Cl. G06F 3/01

(52) U.S. Cl. CPC G06F 3/01
USPC 345/173

(57) ABSTRACT

A method for controlling an electronic device is provided. A file image is displayed on a touch screen of the electronic device. The file image is designated as an object for adjusting in response to a detection of a first contact with the touch screen on the file image. In addition, a location of the first contact is recorded as a standard point. When a second contact with the touch screen is detected, a location of the second contact is recorded as an operation point. An adjusting process is performed on the file image according to a distance between the standard point and the operation point and the relative position of the operation point corresponding to the standard point.

### CROSS REFERENCE TO RELATED APPLICATIONS

This application claims priority of Taiwan Patent Application Ser. No. 101101673, filed 2012 Jan. 17, entitled ELECTRONIC DEVICE AND METHOD FOR CONTROLLING THE SAME. The contents of this application are hereby incorporated by reference.

### BACKGROUND OF THE INVENTION

1. Field of the Invention

The disclosure relates generally to electronic devices with touch screen displays and, more particularly to adjusting the display of a file image according to detected user gestures on the touch screen display.

2. Description of the Related Art

As portable electronic devices become more compact, and the number of functions performed by a given device increase, it has become a significant challenge to provide a user interface that allows users to easily interact with a multifunctional device. This challenge is particularly significant for handheld portable devices, which have much smaller screens than desktop or laptop computers.

Some handheld portable devices have resorted to adding more push buttons, increasing the density of the push buttons, overloading the functions of the push buttons, or using complex menu systems to allow a user to access, store and manipulate data. These conventional user interfaces, however, are inflexible and inconvenient.

Accordingly, there is a need for more user-friendly and intuitive procedures for manipulating handheld devices.

### BRIEF SUMMARY OF THE INVENTION

A method of controlling an electronic device with a touch-sensitive screen and an electronic device are provided.

In an embodiment of a method for controlling an electronic device with a touch-sensitive screen, a file image of a file is displayed on a graphical user interface. Upon detection of a first contact with the file image on the touch-sensitive screen, the file image is designated as an object for adjusting, and coordinates of the first contact are recorded as a standard point. Upon detection of a second contact with the file image on the touch-sensitive screen, coordinates of the second contact are recorded as an operation point. An adjusting process is performed on the file image according to a distance between the standard point and the operation point and a relative position of the operation point corresponding to the standard point.

According to an embodiment, the graphical user interface is divided into a first area and a second area corresponding to the standard point. A first process is performed on the file image when the operation point is located in the first area, and a second process is performed on the file image when the operation point is located in the second area.

According to an embodiment, the first area is an area on an upper side of the graphical user interface corresponding to the standard point, and the second area is an area on a lower side of the graphical user interface corresponding to the standard point. The first process is an enlarging process for increasing the displayed size of the file image, and the second process is a downsizing process for decreasing the displayed size of the file image. An enlargement ratio for the enlarging process or a downsizing ratio for the downsizing process is determined according to the distance between the standard point and the operation point.

According to an embodiment, the first area is an area on a right side of the graphical user interface corresponding to the standard point, and the second area is an area on a left side of the graphical user interface corresponding to the standard point. The first process is a right rotating process for rotating the file image 90 degrees clockwise, and the second process is a left rotating process for rotating the file image 90 degrees counterclockwise.

An embodiment of an electronic device includes a touch-sensitive screen and a controller. The touch-sensitive screen displays a file image of a file on a graphical user interface. The controller designates the file image as an object for adjusting, and records coordinates of the first contact as a standard point upon detection of a first contact with the file image on the touch-sensitive screen. The controller, upon detection of a second contact with the file image on the touch-sensitive screen, records coordinates of the second contact as an operation point. In addition, the controller performs an adjusting process on the file image according to a distance between the standard point and the operation point and a relative position of the operation point corresponding to the standard point.

Methods of controlling an electronic device with a touch-sensitive screen, and related operating systems may take the form of a program code embodied in a non-transitory tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electronic device of the invention;

FIGS. 2A-2C illustrate flowcharts of an embodiment of a method of controlling an electronic device with a touch-sensitive screen;

FIGS. 3A-3H illustrates graphical user interface displays of an electronic device according to embodiments of the invention.

### DETAILED DESCRIPTION OF THE INVENTION

Method of controlling an electronic device with a touch-sensitive screen and electronic device are provided.

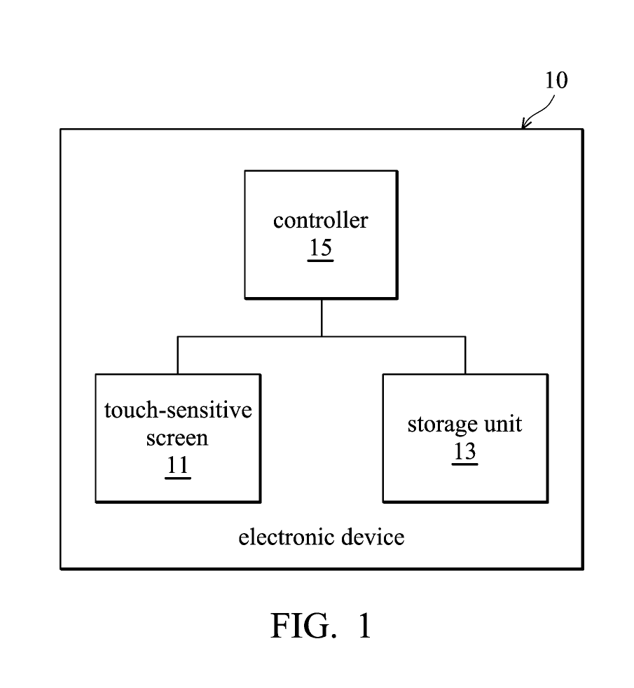

FIG. 1 is a schematic diagram illustrating an embodiment of an electronic device of the invention. According to an embodiment, an electronic device 10 can be a personal computer or portable electronic device, such as a PDA (Personal Digital Assistant), a mobile phone, a smart phone, and a mobile Internet Device (MID).

The electronic device 10 comprises a touch-sensitive screen 11, a storage unit 13, and a controller 15.

The touch-sensitive screen 11 has a touch-sensitive surface. The touch-sensitive screen 11 can detect contact and movement of an input tool, such as a stylus or finger on the touch-sensitive surface. The touch-sensitive screen 11 can display related graphics, data, and interfaces. The touch-sensitive screen 11 receives inputs corresponding to user manipulation, and transmits the received inputs to the controller 15 for further processing.

The storage unit 13 stores personal data, settings and software of the electronic device 10.

The controller 15 executes a method of controlling an electronic device with a touch-sensitive screen of the invention. Related details are discussed later.

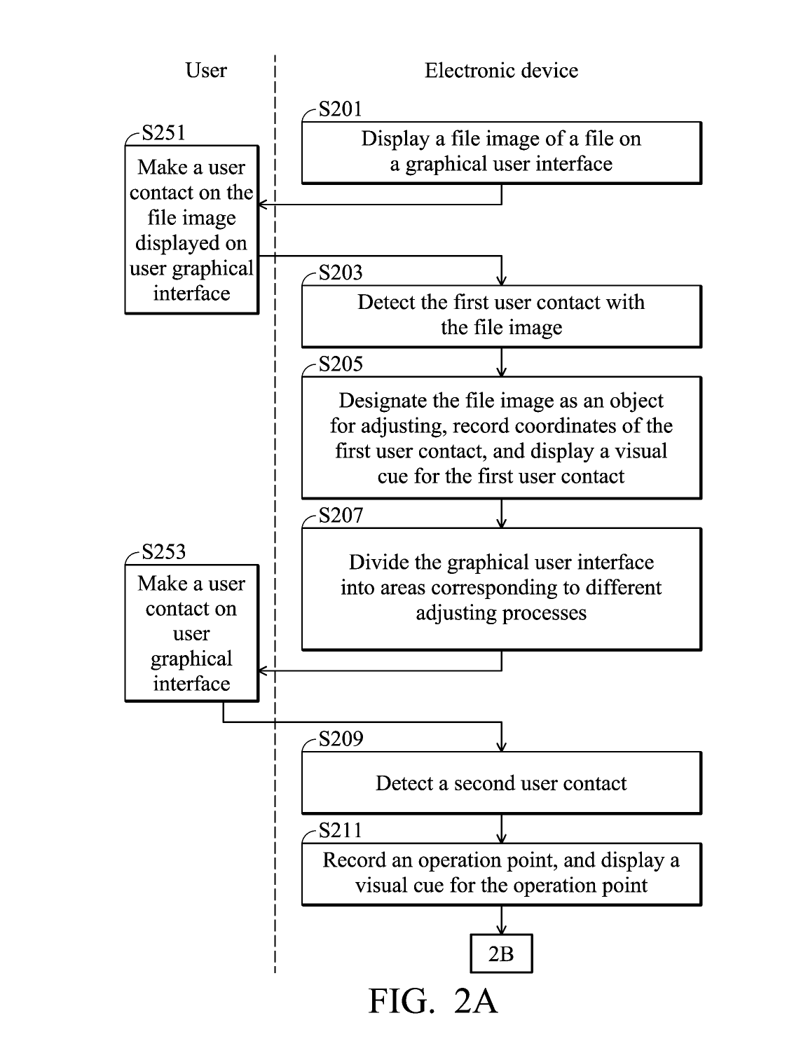

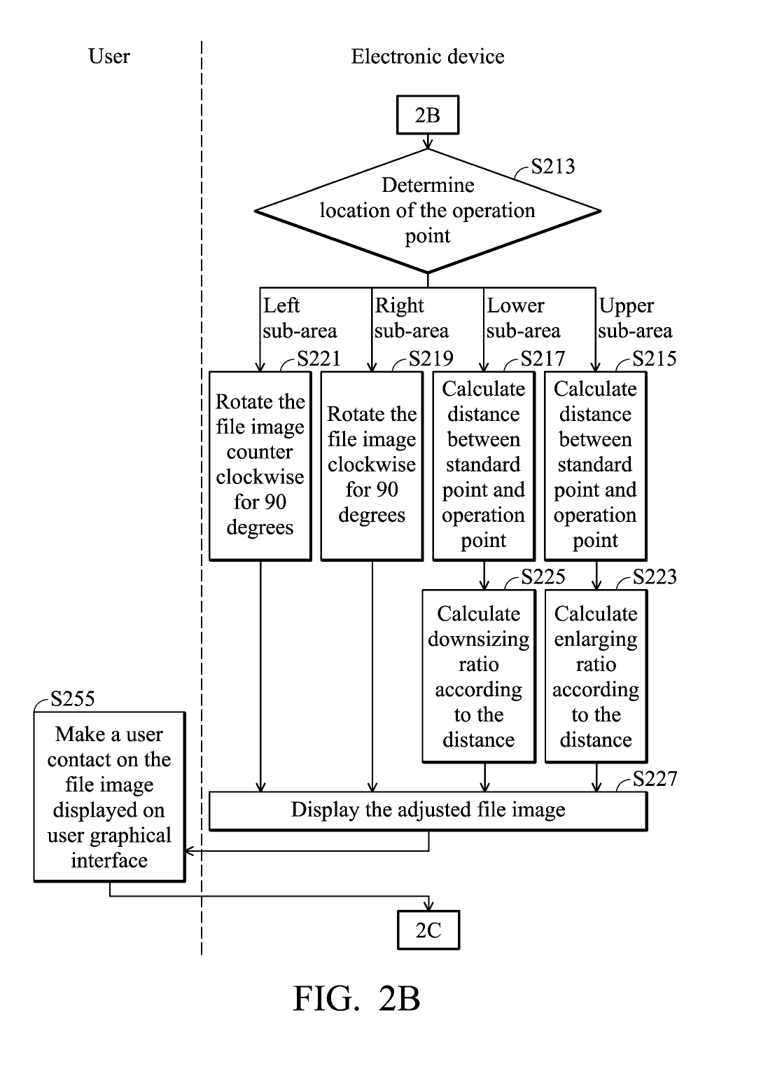

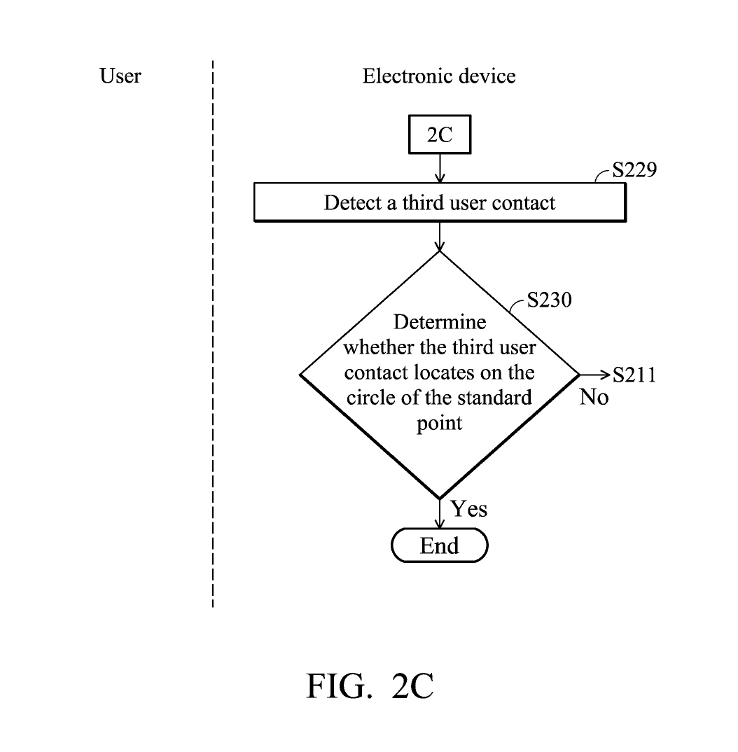

FIGS. 2A-2C illustrate flowcharts of an embodiment of a method of controlling an electronic device with a touch-sensitive screen. The method of controlling an electronic device with a touch-sensitive screen can be used in an electronic device, including but not limited to a PDA (Personal Digital Assistant), a smart phone, a mobile phone, or the like. According to an embodiment, the electronic device is equipped with a touch-sensitive screen.

While the process flow described below includes a number of operations that appear to occur in a specific order, it should be apparent that these processes may include more or fewer operations, which may be executed serially or in parallel (for example, using parallel processors or a multi-threading environment).

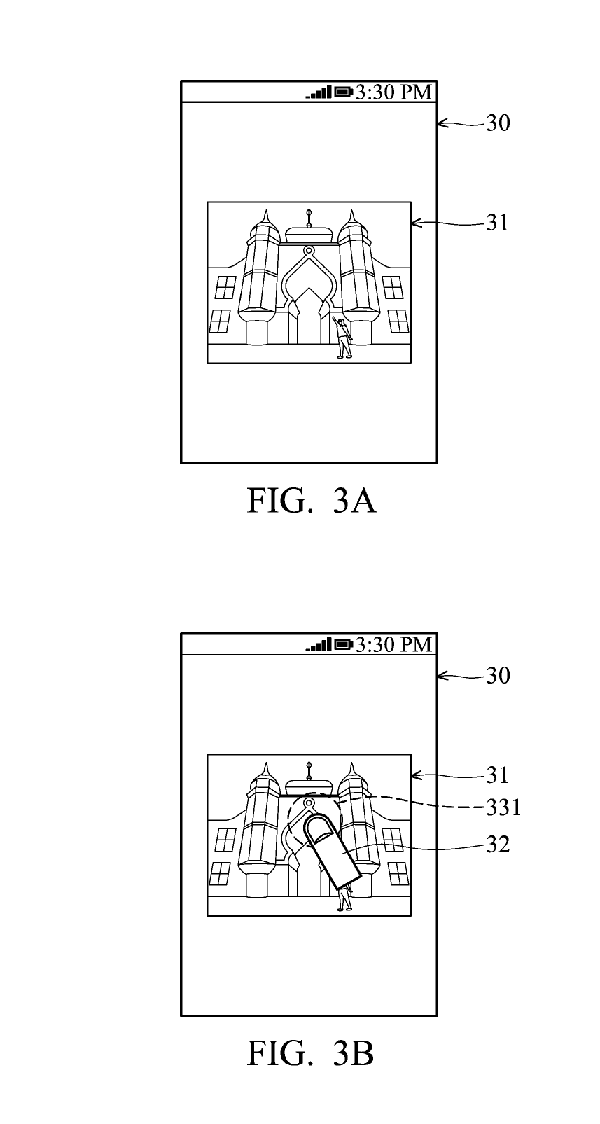

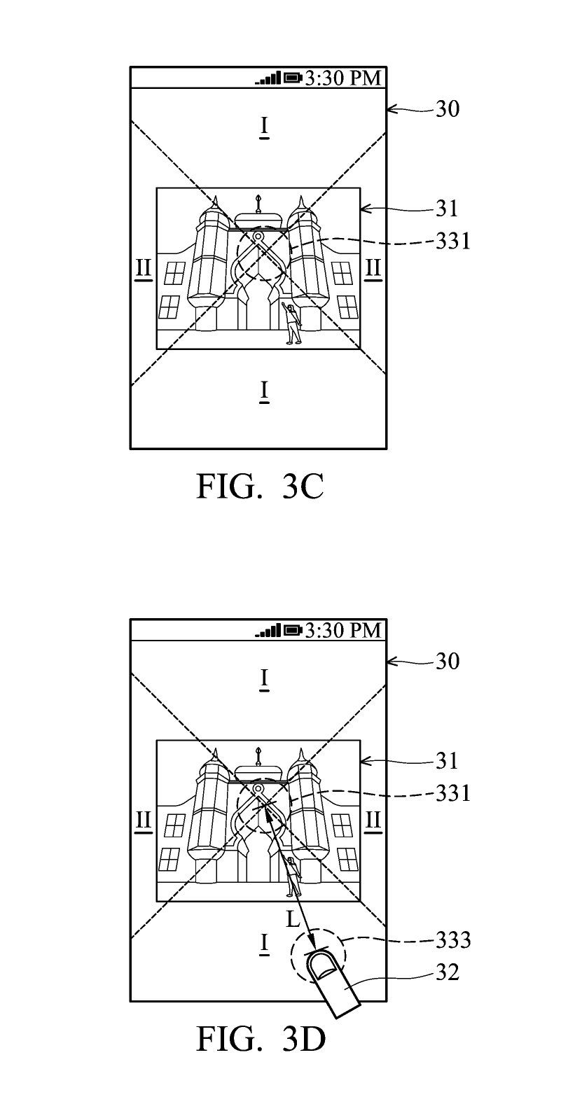

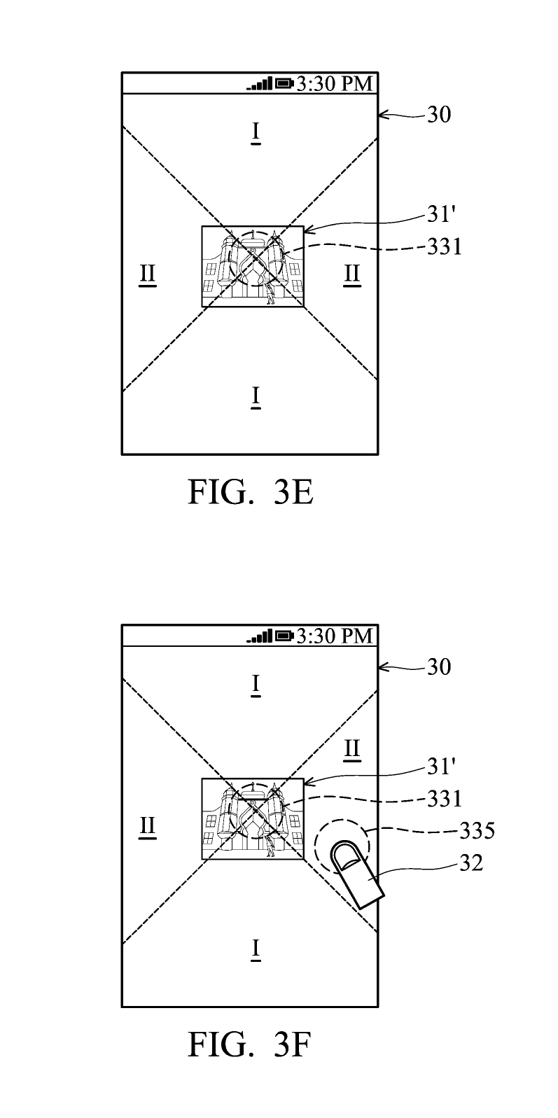

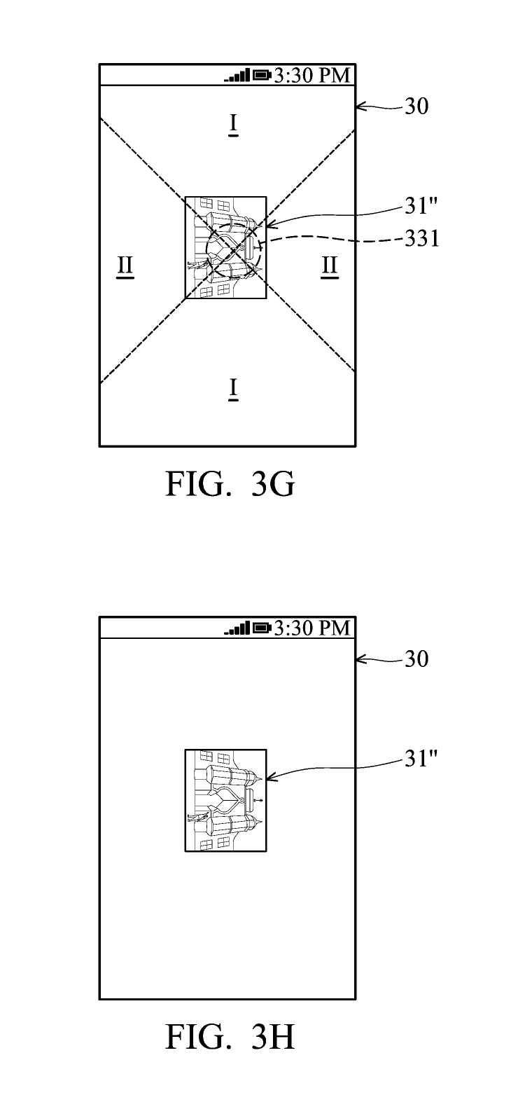

In step S201, a file image of a file is displayed on a graphical user interface provided by a touch-sensitive screen equipped in an electronic device. Referring to FIG. 3A, a file image 31 (object of adjustment) of a file is displayed on a graphical user interface 30 provided by a touch-sensitive screen. According to this embodiment, the file image 31 is an image of a photograph file. It should be apparent that the invention is not limited to this example, and the file image 31 can be an image of any file.

In step S251, a user contact (first user contact) is made on the file image. Upon detection of the first user contact with the file image on the touch-sensitive screen (step S203), the file image 31 is designated, by the electronic device 10, as an object for adjusting, and coordinates of the user contact (first user contact) are recorded as a standard point (step S205). In addition, a visual cue for the standard point can be displayed around the standard point.

Referring to FIG. 3B, when a user uses a finger 32 (or other input tool) to make contact with the file image 31 on the graphical user interface 30, the touch-sensitive screen detects the finger contact on the file image 31. Upon the detection, the file image 31 is designated, by the electronic device 10, as an object for adjusting, and coordinates of the user contact (first contact) are recorded as a standard point (not shown). In addition, a visual cue (circle 331) can be displayed around the standard point. If the user does not want an adjusting process to be performed after the finger contact has been made, the user can stop method by making a finger contact again on the area surrounded by the circle 331.

According to this embodiment, the user can designate a file image as an object for an adjusting process by simply making a finger contact with the file image on the touch-sensitive screen.

In step S207, the graphical user interface is divided into a first area (I) and a second area (II) corresponding to the standard point (presented by a circle 331).

As shown in FIG. 3C, in this embodiment, the graphical user interface 30 is divided into a first area (I) and a second area (II) corresponding to the standard point (presented by circle 331). According to this embodiment, the first area (I) includes areas on an upper side and lower side of the graphical user interface 30 corresponding to the standard point(presented by circle 331). The second area (II) includes areas on right and left sides of the graphical user interface 30 corresponding to the standard point (presented by circle 331). In FIG. 3C, the first area (I) and the second area (II) are separated by a dotted line. The dotted line, which is simply an example, can be left out. In addition, other visual cues can be provided to help users distinguish the first area (I) from the second area (II). For example, the first area (I) and the second area (II) can be displayed as areas with different screen tones or shadows. It should be clear that the first area (I) and the second area (II) can also be presented without any visual cues.

In addition, according to this embodiment, the first area (I) can be further divided into two sub-areas, i.e., an upper sub-area and a lower sub-area. The upper sub-area corresponds to an enlarging process for increasing the displayed size of the file image, while the lower sub-area corresponds to a downsizing process for decreasing the displayed size of the file image.

Similarly, the second area (II) is also divided into two sub-areas, i.e., a right sub-area and a left sub-area. The right sub-area corresponds to a right rotating process for rotating the file image 90 degrees clockwise, while the left sub-area corresponds to a left rotating process for rotating the file image 90 degrees counterclockwise.

In step S253, another user contact is made on the file image. At this moment, the second user contact with the file image on the touch-sensitive screen is detected (step S209).

In step S211, coordinates of the second user contact (second user contact) are recorded as an operation point. In addition, a visual cue for the operation point can be displayed around the operation point.

According to this embodiment, a first process is performed on the file image when the operation point is located in the first area, while a second process is performed on the file image when the operation point is located in the second area. For example, an enlarging or downsizing process is performed on the file image when the operation point is located in the first area, and a rotating process is performed on the file image when the operation point is located in the second area. The first area can be further divided into two sub-areas, wherein one sub-area corresponds to an enlarging process, and the other sub-area corresponds to a downsizing process. In addition, an enlargement ratio for the enlarging process or a downsizing ratio for the downsizing process can be determined according to the distance between the standard point and the operation point. Similarly, the second area can be divided into two sub-areas, wherein one sub-area corresponds to a right rotating process for rotating the file image 90 degrees clockwise, and the other sub-area corresponds to a left rotating process for rotating the file image 90 degrees counterclockwise.

As shown in FIG. 3D, when a user uses a finger 32 (or other input tool) to make a second contact (on a position away from the first contact) with the file image 31 on the graphical user interface 30, the touch-sensitive screen records coordinates of the second contact as an operation point upon detection of the second contact. In addition, another visual cue is displayed around the operation point (shown as a circle 333 presented by dotted lines).

In step S213, it is determined whether the operation point is positioned on the upper sub-area or lower sub-area of the first area (I), or the operation point is positioned on the right sub-area or left sub-area of the second area (II).

If the operation point is located in the upper sub-area of the first area (I), the method proceeds to step S215, if the operation point is located in the lower sub-area of the first area (I), the method proceeds to step S217, if the operation point is located in the right sub-area of the second area (II), the method proceeds to step S219 to rotate the file image 31 rightwards for 90 degrees, and if the operation point is located in the left sub-area of the second area (II), the method proceeds to step S221 to rotate the file image 31 leftwards for 90 degrees.

In step S215, a distance from the standard point to the operation point is calculated according to the standard point determined in step S205 and the operation point determined in the step S211. In step S223, an enlargement ratio for the enlarging process is determined according to the distance between the standard point and the operation point. In step S227, an adjusted file image 31′ is displayed (herein the adjusted file image is obtained by enlarging the file image 31).

In step S217, a distance from the standard point to the operation point is calculated according to the standard point determined in step S205 and the operation point determined in the step S211. In step S225, a downsizing ratio for the downsizing process is determined according to the distance between the standard point and the operation point. In step S227, an adjusted file image 31′ is displayed (herein the adjusted file image is obtained by downsizing the file image 31).

According to this embodiment, calculation of the enlargement ratio and downsizing ratio can be implemented by a ‘unit distance’ method. For example, a certain length is specified as a ‘unit’ of distance. When the distance between the standard point and the operation point equals to one unit of distance, the file image is to be enlarged or downsized by 1%.

Referring to FIG. 3D, according to this embodiment, the operation point is located in the lower sub-area of the first area (I), away from the standard point at a distance of 50 units. Based on predetermined settings, a downsizing process is to be performed on the file image 31. In according to a calculation result, the file image 31 is to be downsized to 50% of its original size. The downsizing ratio increases as the distance between the standard point and the operation point increases.

Referring to FIG. 3E, an adjusted file image 31′ is presented. That is, the file image 31 is downsized to 50% of its original size, according to the downsizing ratio obtained in step S225, and a downsized file image 31′ is presented. Here, the adjusting process has not ends yet. On the graphical user interface 30, the adjusted file image 31′ is shown together with the circle 331 for the standard point.

Similarly, when the operation point is located in the upper sub-area of the first area (I), away from the standard point at a distance of 50 units. Based on predetermined settings, an enlarging process is to be performed on the file image 31. According to a calculation result, the file image 31 is to be enlarged by 50% of its original size. The enlarging ratio increases as the distance between the standard point and the operation point increases.

When the operation point is located in the right sub-area of the second area (II), the method proceeds to step S219 to rotate the file image 31 clockwise (rightwards) for 90 degrees. In step S227, an adjusted file image 31′ is displayed (herein the adjusted file image is obtained by rotating the file image 31 clockwise).

In this embodiment, when a user makes one finger contact on the right sub-area of the second area (II), the file image 31 is rotated clockwise for 90 degrees. Accordingly, in this situation, there is no need to calculate the distance between the standard point and the operation point.

When the operation point is located in the left sub-area of the second area (II), the method proceeds to step S221 to rotate the file image 31 counter clockwise (leftwards) for 90 degrees. In step S227, an adjusted file image 31′ is displayed (herein the adjusted file image is obtained by rotating the file image 31 counter clockwise).

In this embodiment, when a user makes one finger contact on the left sub-area of the second area (II), the file image 31 is rotated counter clockwise for 90 degrees. Accordingly, in this situation, there is no need to calculate the distance between the standard point and the operation point.

When the user makes finger contact with the user graphical interface again (step S255), a third user contact is detected (step S229). Then in step S230, it is determined whether the third contact is located within the circle 331, and if so, the method ends.

If the third contact is located within a position other than the circle 331, the method returns to step S211 to continue the adjusting process of file image 31. Here, the adjusting process is performed on the file image obtained in step S227. That is, the file image 31′ serves as a starting file, and an enlarging, downsizing, right-rotating, or left-rotating process is performed on the file image 31′.

In other words, the user can stop the adjusting process by simply making another finger contact on the circle 331. The user can further adjust the file image by making a finger contact on either the first area or the second area.

For example, in this embodiment, when the user wants to further rotate the image file 31′ clockwise, a second finger contact can be made on the right sub-area of the second area (II). As shown in FIG. 3F, when the right sub-area of the second area (II) is touched by the finger 32, the method returns to step S211, wherein coordinates of the current finger contact are recorded as an operation point, and a visual cue (a circle 335 presented by dotted lines in FIG. 3F) is presented around the operation point.

As shown in FIG. 3F, the circle 335 is located on the right sub-area of the second area (II), therefore the method again proceeds to step S219, and the file image 31′ is then rotated clockwise for 90 degrees. On the graphical user interface 30, the rotated file image 31″ is shown together with circle 331 for the standard point. If the user does not want an adjusting process to be performed (i.e., end the adjusting process), the user can stop the method by making a finger contact again on the area surrounded by the circle 331. Here, the file image 31″ is shown without the circle 331, as shown in FIG. 3H.

In addition, a timer can be implemented in the described embodiment. For example, if another contact is not detected during a predetermined period (5 seconds, for example), the adjusting process ends.

For the foregoing description, for purpose of explanation, specific embodiments have been used. However, the illustrative discussions above are not intended to be exhaustive or to limit the invention to the precise forms disclosed.

Methods of controlling an electronic device, and related operating systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for controlling an electronic device with a touch-sensitive screen, comprising:
displaying a file image of a file on a graphical user interface;
upon detection of a first contact with the file image on the touch-sensitive screen, designating the file image as an object for adjusting, and recording coordinates of the first contact as a standard point;
upon detection of a second contact with the file image on the touch-sensitive screen, recording coordinates of the second contact as an operation point; and
performing an adjusting process on the file image according to a distance between the standard point and the operation point and a relative position of the operation point corresponding to the standard point.

2. The method of claim 1, further comprising:
dividing the graphical user interface into a first area and a second area corresponding to the standard point;
performing a first process on the file image when the operation point is located in the first area; and
performing a second process on the file image when the operation point is located in the second area.

3. The method of claim 2, wherein:
the first process is an enlarging process for increasing the displayed size of the file image, and the second process is a downsizing process for decreasing the displayed size of the file image; and
the method further determines an enlargement ratio for the enlarging process or a downsizing ratio for the downsizing process according to the distance between the standard point and the operation point.

4. The method of claim 3, wherein the first area is an area on an upper side of the graphical user interface corresponding to the standard point, and the second area is an area on a lower side of the graphical user interface corresponding to the standard point.

5. The method of claim 2, wherein:
the first process is a right rotating process for rotating the file image 90 degrees clockwise; and
the second process is a left rotating process for rotating the file image 90 degrees counterclockwise.

6. The method of claim 5, wherein the first area is an area on a right side of the graphical user interface corresponding to the standard point, and the second area is an area on a left side of the graphical user interface corresponding to the standard point.

7. The method of claim 1, further displaying a visual cue for standard point around the standard point.

8. The method of claim 1, further displaying a visual cue for operation point around the operation point.

9. An electronic device, comprising:
a touch-sensitive screen for displaying a file image of a file on a graphical user interface; and
a controller, for designating the file image as an object for adjusting, and recording coordinates of the first contact as a standard point upon detection of a first contact with the file image on the touch-sensitive screen,
wherein:
the controller, upon detection of a second contact with the file image on the touch-sensitive screen, records coordinates of the second contact as an operation point; and
the controller performs an adjusting process on the file image according to a distance between the standard point and the operation point and a relative position of the operation point corresponding to the standard point.

10. The electronic device of claim 9, wherein the controller further divides the graphical user interface into a first area and a second area corresponding to the standard point, and performs a first process on the file image when the operation point is located in the first area, and performs a second process on the file image when the operation point is located in the second area.

11. The electronic device of claim 10, wherein:
the first process performed by the controller is an enlarging process for increasing the displayed size of the file image, and the second process performed by the controller is a downsizing process for decreasing the displayed size of the file image; and
the controller further determines an enlargement ratio for the enlarging process or a downsizing ratio for the downsizing process according to the distance between the standard point and the operation point.

12. The electronic device of claim 11, wherein the controller designates the first area as an area on an upper side of the graphical user interface corresponding to the standard point, and designates the second area as an area on a lower side of the graphical user interface corresponding to the standard point.

13. The electronic device of claim 10, wherein:
the first process performed by the controller is a right rotating process for rotating the file image 90 degrees clockwise; and
the second process performed by the controller is a left rotating process for rotating the file image 90 degrees counterclockwise.

14. The electronic device of claim 13, wherein the controller designates the first area as an area on a right side of the graphical user interface corresponding to the standard point, and designates the second area as an area on a left side of the graphical user interface corresponding to the standard point.

15. The electronic device of claim 9, wherein the controller further controls the touch-sensitive screen to display a visual cue for standard point around the standard point.

16. The electronic device of claim 9, wherein the controller further controls the touch-sensitive screen to display a visual cue for the operation point around the operation point.
